(19) United States
(12) Patent Application Publication
(10) Pub. No.: US 2014/0036529 A1
(43) Pub. Date: Feb. 6, 2014

(54) LIGHT SOURCE DEVICE, DISPLAY UNIT, AND ELECTRONIC APPARATUS

(71) Applicant: Sony Corporation, Tokyo (JP)

(72) Inventors: Mamoru Suzuki, Tokyo (JP); Masaru Minami, Kanagawa (JP)

(73) Assignee: Sony Corporation, Tokyo (JP)

(21) Appl. No.: 13/952,229

(22) Filed: Jul. 26, 2013

(30) Foreign Application Priority Data
Jul. 31, 2012 (JP) 2012-169218

(51) Int. Cl. F21V 8/00

(52) U.S. Cl. CPC G02B 6/0053
USPC 362/606

(57) ABSTRACT

A display unit includes: a display section displaying an image; and a light source device emitting light for image display toward the display section, the light source device including one or more first light sources, a light guide plate, and an optical member, the first light sources emitting first illumination light, the light guide plate including a plurality of scattering regions that allow the first illumination light to be scattered and then to exit from the light guide plate, the optical member being disposed on a light-emission side of the light guide plate to face the light guide plate and allowing an angular distribution of luminance of the first illumination light emitted from the light guide plate to be varied.

### BACKGROUND

The present disclosure relates to a light source device and a display unit capable of achieving stereoscopic vision by a parallax barrier system, and an electronic apparatus.

As one of stereoscopic display systems capable of achieving stereoscopic vision with naked eyes without wearing special glasses, a parallax barrier system stereoscopic display unit is known. In the stereoscopic display unit, a parallax barrier is disposed to face a front side (a display plane side) of a two-dimensional display panel. In a typical configuration of the parallax barrier, shielding sections shielding display image light from the two-dimensional display panel and stripe-shaped opening sections (slit sections) allowing the display image light to pass therethrough are alternately arranged in a horizontal direction.

In the parallax barrier system, parallax images for stereoscopic vision (a right-eye parallax image and a left-eye parallax image in the case of two perspectives) which are spatially separated from one another are displayed on the two-dimensional display panel, and the parallax images are separated in the horizontal direction by the parallax barrier to achieve stereoscopic vision. When a slit width or the like in the parallax barrier is appropriately determined, in the case where a viewer watches the stereoscopic display unit from a predetermined position and a predetermined direction, light rays from different parallax images enter respective right and left eyes of the viewer through the slit sections.

It is to be noted that, in the case where, for example, a transmissive liquid crystal display panel is used as the two-dimensional display panel, a parallax barrier may be disposed behind the two-dimensional display panel (refer to FIG. 10 in Japanese Patent No. 3565391 and FIG. 3 in Japanese Unexamined Patent Application Publication No. 2007-187823). In this case, the parallax barrier is disposed between the transmissive liquid crystal display panel and a backlight.

### SUMMARY

In parallax barrier system stereoscopic display units, a component exclusive for three-dimensional display, i.e., a parallax barrier is necessary; therefore, more components and a larger space for the components are necessary, compared to a typical display unit for two-dimensional display.

It is desirable to provide a light source device and a display unit capable of achieving a function equivalent to a parallax barrier with use of a light guide plate and obtaining illumination light with a desired angular distribution of luminance, and an electronic apparatus.

According to an embodiment of the present disclosure, there is provided a light source device including: one or more first light sources emitting first illumination light; a light guide plate including a plurality of scattering regions that allow the first illumination light to be scattered and then to exit from the light guide plate; and an optical member disposed on a light-emission side of the light guide plate to face the light guide plate and allowing an angular distribution of luminance of the first illumination light emitted from the light guide plate to be varied.

According to an embodiment of the present disclosure, there is provided a display unit including: a display section displaying an image; and a light source device emitting light for image display toward the display section, the light source device including one or more first light sources, a light guide plate, and an optical member, the first light sources emitting first illumination light, the light guide plate including a plurality of scattering regions that allow the first illumination light to be scattered and then to exit from the light guide plate, the optical member being disposed on a light-emission side of the light guide plate to face the light guide plate and allowing an angular distribution of luminance of the first illumination light emitted from the light guide plate to be varied.

According to an embodiment of the present disclosure, there is provided an electronic apparatus provided with a display unit, the display unit including: a display section displaying an image; and a light source device emitting light for image display toward the display section, the light source device including one or more first light sources, a light guide plate, and an optical member, the first light sources emitting first illumination light, the light guide plate including a plurality of scattering regions that allow the first illumination light to be scattered and then to exit from the light guide plate, the optical member being disposed on a light-emission side of the light guide plate to face the light guide plate and allowing an angular distribution of luminance of the first illumination light emitted from the light guide plate to be varied.

In the light source device, the display unit, and the electronic apparatus according to the embodiments of the present disclosure, the first illumination light from the first light source is scattered by the scattering regions to exit from the light guide plate. Therefore, the light guide plate has a function as a parallax barrier for the first illumination light. In other words, the light guide plate equivalently functions as a parallax barrier with the scattering regions as opening sections (slit sections). Therefore, three-dimensional display is possible. Moreover, the angular distribution of luminance of the first illumination light emitted from the light guide plate is varied by the optical member.

In the light source device, the display unit, and the electronic apparatus according to the embodiments of the present disclosure, the light guide plate has the plurality of scattering regions allowing the first illumination light to be scattered; therefore, the light guide plate equivalently has a function as a parallax barrier for the first illumination light. Moreover, the optical member allowing the angular distribution of luminance of the first illumination light emitted from the light guide plate to be varied is provided; therefore, illumination light with a desired angular distribution of luminance is obtainable.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the technology, and are incorporated in and constitute a part of this specification. The drawings illustrate embodiments and, together with the specification, serve to explain the principles of the technology.

FIG. 1 is a sectional view illustrating a configuration example of a display unit according to a first embodiment of the present disclosure.

FIG. 2 is a plan view illustrating an example of a pixel configuration of a display section.

FIG. 3 is a sectional view illustrating an example of a state of emission of light rays when only a first light source is maintained in an ON (turned-on) state.

FIG. 4 is a plan view illustrating an example of an in-plane light emission pattern when only the first light source is maintained in the ON (turned-on) state.

FIG. 5 is a sectional view illustrating an example of a state of emission of light rays when only a second light source is maintained in the ON (turned-on) state.

FIG. 6 is a plan view illustrating an example of an in-plane light emission pattern when only the second light source is maintained in the ON (turned-on) state.

FIG. 7 is an explanatory diagram illustrating a first configuration example of scattering regions when the first light sources are disposed on a top side and a bottom side.

FIG. 8 is an explanatory diagram illustrating a second configuration example of the scattering regions when the first light sources are disposed on the top side and the bottom side.

FIG. 9 is an explanatory diagram illustrating a configuration example of the scattering regions when only one first light source is provided.

FIG. 10 is an explanatory diagram illustrating a configuration example of the scattering regions when the first light sources are disposed on a right side and a left side.

FIG. 11 is a sectional view illustrating an example of an angular distribution of luminance of light emitted from the first light source and an angular distribution of luminance of light emitted from the second light source.

FIG. 12 is an explanatory diagram illustrating an example of the angular distribution of luminance of the light emitted from the first light source or the angular distribution of luminance of the light emitted from the second light source.

FIG. 13 is a sectional view illustrating a configuration example of a reverse prism.

FIG. 14 is a sectional view illustrating an example of variation in angular distribution of luminance of light by a reverse prism sheet.

FIG. 15 is an explanatory diagram illustrating an example of variation in angular distribution of luminance of light by the reverse prism sheet.

FIG. 16 is a plan view and a sectional view illustrating an example of the angular distribution of luminance of the light emitted from the first light source.

FIG. 17 is a plot illustrating an example of an angular distribution of luminance of light emitted from the first light source in a first region.

FIG. 18 is a plot illustrating an example of an angular distribution of luminance of light emitted from the first light source in a second region.

FIG. 19 is a plot illustrating an example of an angular distribution of luminance of light emitted from the first light source in a third region.

FIG. 20 is a sectional view illustrating an example of variation in angular distribution of luminance of light by the reverse prism sheet when only one first light source is provided.

FIG. 21 is an explanatory diagram illustrating an example of variation in angular distribution of luminance of light by the reverse prism sheet when only one first light source is provided.

FIG. 22 is a plan view illustrating a relationship between a pattern of the scattering region and a ridgeline of a reverse prim when the first light sources are disposed on the top side and the bottom side.

FIG. 23 is a plan view illustrating a relationship between a pattern of the scattering region and the ridgeline of the reverse prism when the first light sources are disposed on the right side and the left side.

FIG. 24 is an explanatory diagram of an observation direction of an in-plane light emission pattern.

FIG. 25 is an enlarged plan view illustrating a light emission state when a light guide plate is viewed from a front direction in the case where the pattern of the scattering region and the ridgeline of the reverse prism are orthogonal to each other.

FIG. 26 is an enlarged plan view illustrating a first example of a light emission state when the light guide plate is viewed from the front direction in the case where the pattern of the scattering region and the ridgeline of the reverse prism are not orthogonal to each other.

FIG. 27 is an enlarged plan view illustrating a second example of the light emission state when the light guide plate is viewed from the front direction in the case where the pattern of the scattering region and the ridgeline of the reverse prism are not orthogonal to each other.

FIG. 28 is a sectional view illustrating an effect obtained through arranging the pattern of the scattering region and the ridgeline of the reverse prism orthogonal to each other.

FIG. 29 is a plot illustrating an example of an angular distribution of luminance in a horizontal direction of light emitted from the first light source.

FIG. 30 is a plot illustrating an example of an angular distribution of luminance in a vertical direction of light emitted from the first light source.

FIG. 31 is a plot illustrating an example of an angular distribution of luminance in the horizontal direction of light emitted from the second light source.

FIG. 32 is a plot illustrating an example of an angular distribution of luminance in the vertical direction of light emitted from the second light source.

FIG. 33 is a sectional view illustrating a configuration example of a display unit according to a second embodiment.

FIG. 34 is a sectional view illustrating a configuration example of an upward prism.

FIG. 35 is a sectional view illustrating a configuration example of a display unit according to a third embodiment.

FIG. 36 is a sectional view illustrating a configuration example of a display unit according to a fourth embodiment.

FIG. 37 is a sectional view illustrating a first configuration example of a display unit according to a fifth embodiment.

FIG. 38 is a sectional view illustrating a second configuration example of the display unit according to the fifth embodiment.

FIG. 39 is a plan view illustrating a modification of the pattern of the scattering region.

FIG. 40 is an appearance diagram illustrating an example of an electronic apparatus.

### DETAILED DESCRIPTION

Some embodiments of the present disclosure will be described in detail below referring to the accompanying drawings. It is to be noted that description will be given in the following order.

1. First Embodiment

A configuration example in which a reverse prism sheet is provided as an optical member allowing an angular distribution of luminance of light to be varied

2. Second Embodiment

A configuration example in which an upward prism sheet is provided as an optical member allowing an angular distribution of luminance of light to be varied

3. Third Embodiment

A modification of a position of the reverse prism sheet

4. Fourth Embodiment

A configuration example in which a reflection member is provided

5. Fifth Embodiment

A modification of a second light source

6. Other Embodiments

A configuration example of an electronic apparatus, and the like

### 1. First Embodiment

### Entire Configuration of Display Unit

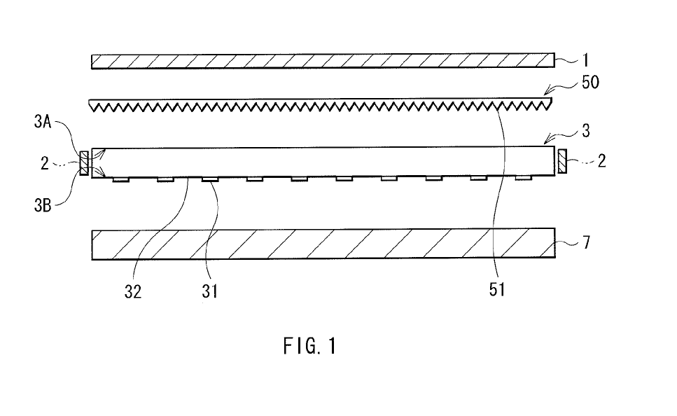

FIG. 1 illustrates a configuration example of a display unit according to a first embodiment of the present disclosure. The display unit includes a display section 1 which displays an image and a light source device which is disposed on a back side of the display section 1 and emits light for image display toward the display section 1. The light source device includes a first light source 2 (a 2D/3D-display light source), a light guide plate 3, and a second light source 7 (a 2D-display light source). The light guide plate 3 has a first internal reflection plane 3A facing the display section 1 and a second internal reflection plane 3B facing the second light source 7. The display unit further includes a reverse prism sheet 50 disposed between the display section 1 and the light guide plate 3. It is to be noted that the display unit includes a control circuit for the display section 1 or the like which is necessary for display; however, the control circuit or the like has a configuration similar to that of a typical control circuit for display or the like, and will not be described here. Moreover, the light source device includes a control circuit (not illustrated) which controls ON (turned-on) and OFF (turned-off) states of the first light source 2 and the second light source 7.

It is to be noted that, in the embodiment, a first direction (a vertical direction) in a display plane (a plane where pixels are arranged) of the display section 1 or a plane parallel to the second internal reflection plane 3B of the light guide plate 3 is referred to as a Y direction, and a second direction (a horizontal direction) orthogonal to the first direction is referred to as an X direction.

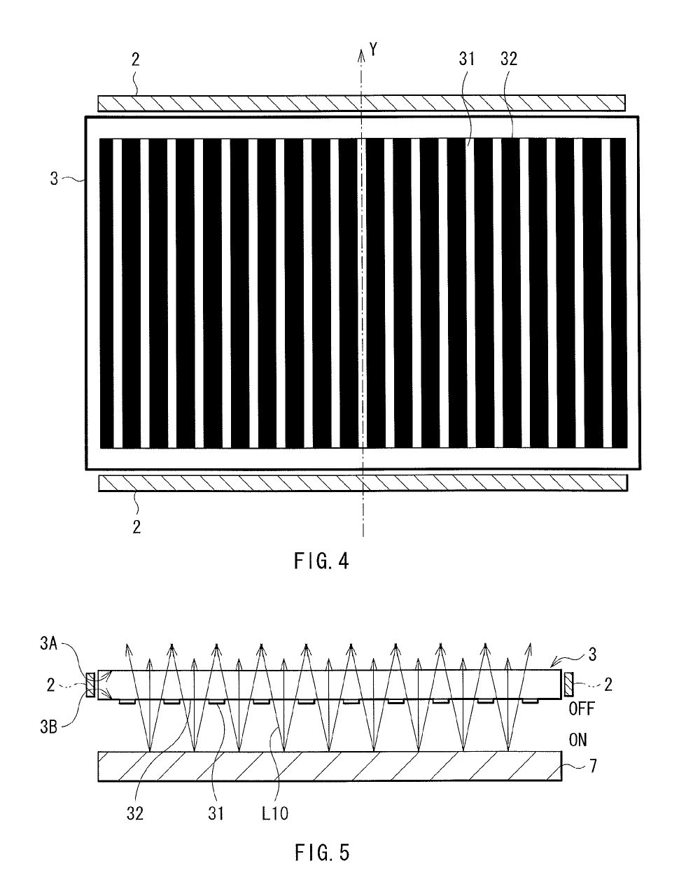

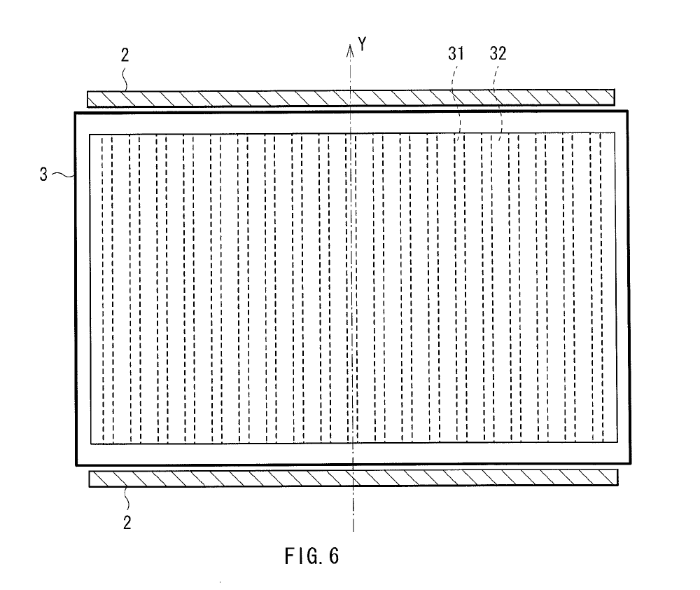

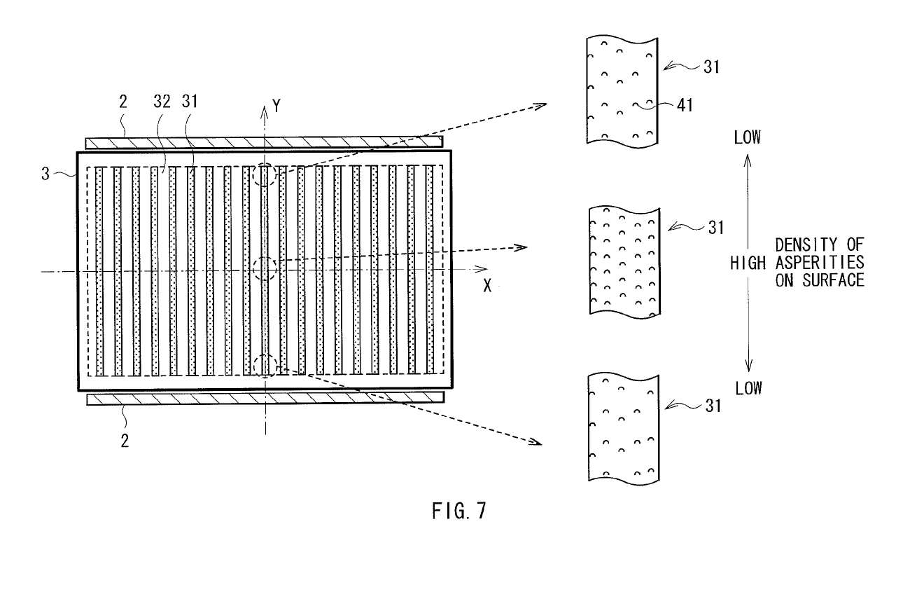

The display unit is capable of arbitrarily and selectively performing switching between a two-dimensional (2D) display mode on an entire screen and a three-dimensional (3D) display mode on the entire screen. Switching between the two-dimensional display mode and the three-dimensional display mode is performed by switching control of image data which is to be displayed on the display section 1 and ON/OFF switching control of the first light source 2 and the second light source 7. FIG. 3 schematically illustrates a state of emission of light rays from the light source device when only the first light source 2 is maintained in an ON (turned-on) state, and corresponds to the three-dimensional display mode. FIG. 4 illustrates an example of an in-plane light emission pattern of light emitted from the light guide plate 3 when only the first light source 2 is maintained in an ON (turned-on) state. FIG. 5 schematically illustrates a state of emission of light rays from the light source device when only the second light source 7 is maintained in an ON (turned-on) state, and corresponds to the two-dimensional display mode. FIG. 6 illustrates an example of an in-plane light emission pattern of light emitted from the light guide plate 3 when only the second light source 7 is maintained in the ON (turned-on) state. It is to be noted that, as illustrated in FIGS. 7 to 10, and the like which will be described later, the first light source 2 may be disposed at any of various positions. FIGS. 4 and 6 illustrate a configuration example when the first light sources 2 are disposed on a first side surface and a second side surface in the vertical direction (the Y direction) in the light guide plate 3 to face each other. FIGS. 1, 3, and 5 illustrate the first light sources 2 as if to be disposed on a third side surface and a fourth side surface in the horizontal direction (the X direction) in the light guide plate 3 to face each other; however, the positions of the first light sources 2 are shown only virtually to describe an emission state of light rays.

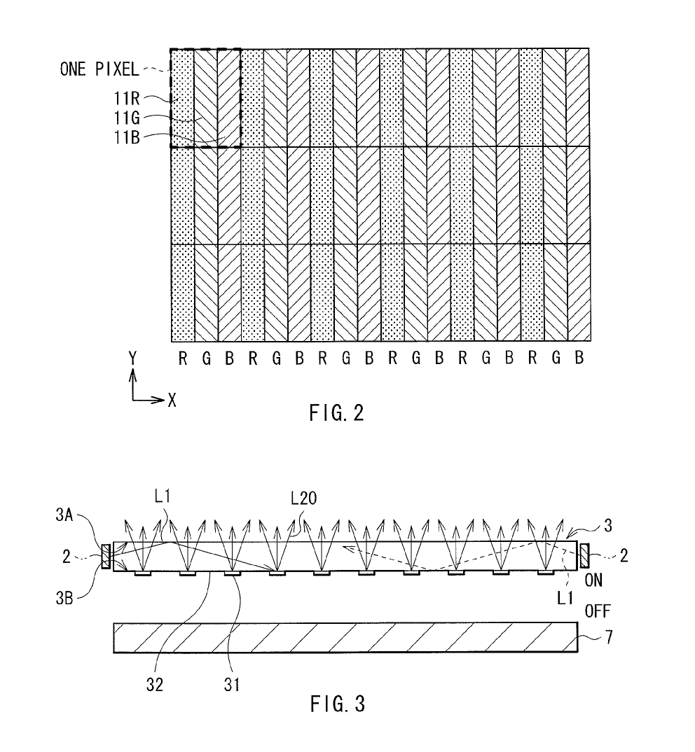

The display section 1 is configured with use of a transmissive two-dimensional display panel, for example, a transmissive liquid crystal display panel. For example, as illustrated in FIG. 2, the display section 1 includes a plurality of pixels 11 configured of, for example, R (red) pixels 11R, G (green) pixels 11G, and B (blue) pixels 11B, and the plurality of pixels 11 are arranged in a matrix form. The display section 1 displays a two-dimensional image through modulating light of each color from the light source device from one pixel 11 to another based on image data. The display section 1 arbitrarily and selectively switches images to be displayed between a plurality of perspective images based on three-dimensional image data and an image based on two-dimensional image data. It is to be noted that the three-dimensional image data is, for example, data including a plurality of perspective images corresponding to a plurality of view angle directions in three-dimensional display. For example, in the case where binocular three-dimensional display is performed, the three-dimensional image data is data including perspective images for right-eye display and left-eye display. In the case where display is performed in the three-dimensional display mode, for example, a composite image including a plurality of stripe-shaped perspective images in one screen is produced and displayed.

The first light source 2 is configured with use of, for example, a fluorescent lamp such as a CCFL (Cold Cathode Fluorescent Lamp), or an LED (Light Emitting Diode). The first light source 2 emits first illumination light L1 (refer to FIG. 3) from a side surface of the light guide plate 3 into an interior thereof. One or more first light sources 2 are disposed on one or more side surfaces of the light guide plate 3. For example, in the case where the light guide plate 3 has a rectangular planar shape, the light guide plate 3 has four side surfaces, and it is only necessary to dispose one or more first light sources 2 on one or more of the four side surfaces. FIG. 1 illustrates a configuration example in which the first light source 2 is disposed on each of two side surfaces facing each other of the light guide plate 3. The first light source 2 is ON (turned-on)/OFF (not turned-on) controlled in response to switching between the two-dimensional display mode and the three-dimensional display mode. More specifically, in the case where the display section 1 displays an image based on the three-dimensional image data (in the case of the three-dimensional display mode), the first light source 2 is controlled to be turned on, and in the case where the display section 1 displays an image based on the two-dimensional image data (in the case of the two-dimensional display mode), the first light source 2 is controlled to be either turned off or turned on.

The second light source 7 is disposed to face the second internal reflection plane 3B of the light guide plate 3. The second light source 7 emits second illumination light L10 toward the light guide plate 3 from a direction different from the direction where the first light source 2 emits the first illumination light L1. More specifically, the second light source 7 emits the second illumination light L10 from an external side (the back side of the light guide plate 3) toward the second internal reflection plane 3B (refer to FIG. 5). The second light source 7 may be a planar light source. For example, a configuration containing a light-emitting body such as a CCFL or an LED and using a light-scattering plate scattering light emitted from the light-emitting body, or the like is considered. The second light source 7 is ON (turned-on)/OFF (turned-off) controlled in response to switching between the two-dimensional display mode and the three-dimensional display mode. More specifically, in the case where the display section 1 displays an image based on the three-dimensional image data (in the case of the three-dimensional display mode), the second light source 7 is controlled to be turned off, and in the case where the display section 1 displays an image based on the two-dimensional image data (in the case of the two-dimensional display mode), the second light source 7 is controlled to be turned on.

The light guide plate 3 is configured of a transparent plastic plate of, for example, an acrylic resin. All surfaces except for the second internal reflection plane 3B of the light guide plate 3 are entirely transparent. For example, in the case where the light guide plate 3 has a rectangular planar shape, the first internal reflection plane 3A and four side surfaces are entirely transparent.

The entire first internal reflection plane 3A is mirror-finished, and allows light rays incident at an incident angle satisfying a total-reflection condition to be reflected, in a manner of total-internal-reflection, in the interior of the light guide plate 3 and allows light rays out of the total-reflection condition to exit therefrom.

The second internal reflection plane 3B has scattering regions 31 and a total-reflection region 32. As will be described later, light-scattering characteristics are added to the scattering regions 31 through performing laser processing, sandblast processing, or the like on a surface of the light guide plate 3. On the second internal reflection plane 3B, in the three-dimensional display mode, the scattering regions 31 and the total-reflection region 32 function as opening sections (slit sections) and a shielding section, respectively, of a parallax barrier for the first illumination light L1 from the first light source 2. On the second internal reflection plane 3B, the scattering regions 31 and the total-reflection region 32 are arranged in a pattern forming a configuration corresponding to a parallax barrier. In other words, the total-reflection region 32 is arranged in a pattern corresponding to a shielding section in the parallax barrier, and the scattering regions 31 each are arranged in a pattern corresponding to an opening section in the parallax barrier. It is to be noted that, as a barrier pattern of the parallax barrier, for example, any of various patterns such as a stripe-shaped pattern in which a large number of vertically long slit-like opening sections are arranged side by side in the horizontal direction with shielding sections in between may be used, and the barrier pattern of the parallax barrier is not specifically limited. FIG. 4 illustrates an example of an in-plane light emission pattern of light emitted from the light guide plate 3 (light L20 (refer to FIG. 3) emitted from the first light source 2) in the case where a plurality of scattering regions 31 extending in the vertical direction are arranged side by side in a striped form.

The first internal reflection plane 3A and the total-reflection region 32 of the second internal reflection plane 3B reflect light rays incident at an incident angle θ1 satisfying a total-reflection condition in a manner of total-internal-reflection (reflect light rays incident at the incident angle θ1 larger than a predetermined critical angle α in a manner of total-internal-reflection). Therefore, the first illumination light L1 incident from the first light source 2 at the incident angle θ1 satisfying the total-reflection condition is guided to a side surface direction by internal total reflection between the first internal reflection plane 3A and the total-reflection region 32 of the second internal reflection plane 3B. Moreover, as illustrated in FIG. 5, the total-reflection region 32 allows the second illumination light L10 from the second light source 7 to pass therethrough and to travel, as a light ray out of the total-reflection condition, toward the first internal reflection plane 3A.

It is to be noted that the critical angle α is represented as follows, where the refractive index of the light guide plate 3 is n1, and the refractive index of a medium (an air layer) outside the light guide plate 3 is n0 (<n1). The angles α and θ1 are angles with respect to a normal to a surface of the light guide plate. The incident angle θ1 satisfying the total-reflection condition is θ1>α.

sin α=n0/n1

As illustrated in FIG. 3, the scattering regions 31 scatter and reflect the first illumination light L1 from the first light source 2 and allow a part or a whole of the first illumination light L1 to travel, as a light ray, i.e., an emission light ray L20, out of the total-reflection condition, toward the first internal reflection plane 3A.

The reverse prism sheet 50 is disposed to face a predetermined side where the first illumination light L1 exits (a side where the display section 1 is disposed) of the light guide plate 3. The reverse prism sheet 50 includes a plurality of reverse prisms 51. The reverse prism sheet 50 optimizes light emitted from the light guide plate 3 through varying an angular distribution of luminance of the first illumination light L1 (the emission light ray L20) emitted from the light guide plate 3 and an angular distribution of luminance of the second illumination light L10 so as to allow the light emitted from the light guide plate 3 to have a desired angular distribution of luminance. Optimization of the angular distribution of luminance of light by the reverse prism sheet 50 will be described in detail later.

### [Basic Operation of Display Unit]

In the case where the display unit performs display in the three-dimensional display mode, the display section 1 displays an image based on the three-dimensional image data, and ON (turned-on)/OFF (turned-off) control of the first light source 2 and the second light source 7 is performed for three-dimensional display. More specifically, as illustrated in FIG. 3, the first light source 2 is controlled to be in the ON (turned-on) state, and the second light source 7 is controlled to be in the OFF (turned-off) state. In this state, the first illumination light L1 from the first light source 2 is reflected repeatedly in a manner of total-internal-reflection between the first internal reflection plane 3A and the total-reflection region 32 of the second internal reflection plane 3B in the light guide plate 3 to be guided from a side surface where the first light source 2 is disposed to the other side surface facing the side surface and then to be emitted from the other side surface. On the other hand, a part of the first illumination light L1 from the first light source 2 is scattered and reflected by the scattering regions 31 of the light guide plate 3 to pass through the first internal reflection plane 3A of the light guide plate 3 and exit from the light guide plate 3. The in-plane light emission pattern of the light emitted from the light guide plate 3 in this case (the emitted light L20 from the first light source 2 (refer to FIG. 3)) is, for example, as illustrated in FIG. 4. Thus, the light guide plate 3 is allowed to have a function as a parallax barrier. In other words, for the first illumination light L1 from the first light source 2, the light guide plate 3 equivalently functions as a parallax barrier with the scattering regions 31 as opening sections (slit sections) and the total-reflection region 32 as a shielding section. Therefore, three-dimensional display by a parallax barrier system in which the parallax barrier is disposed on the back side of the display section 1 is equivalently performed.

On the other hand, in the case where display is performed in the two-dimensional display mode, the display section 1 displays an image based on the two-dimensional image data, and ON (turned-on)/OFF (turned-off) control of the first light source 2 and the second light source 7 is performed for two-dimensional display. More specifically, for example, as illustrated in FIG. 5, the first light source 2 is controlled to be in the OFF (turned-off) state, and the second light source 7 is controlled to be in the ON (turned-on) state. In this case, the second illumination light L10 from the second light source 7 passes through the total-reflection region 32 of the second internal reflection plane 3B to exit as a light ray out of the total-reflection condition from substantially the entire first internal reflection plane 3A of the light guide plate 3. The in-plane light emission pattern of light emitted from the light guide plate 3 in this case (light emitted from the second light source 7) is, for example, as illustrated in FIG. 6. In other words, the light guide plate 3 functions as a planar light source similar to a typical backlight. Therefore, two-dimensional display by a backlight system in which a typical backlight is disposed on the back side of the display section 1 is equivalently performed.

It is to be noted that, when only the second light source 7 is turned on, the second illumination light L10 exits from substantially the entire surface of the light guide plate 3; however, if necessary, the first light source 2 may be turned on. For example, in the case where there is a difference in a luminance distribution between portions corresponding to the scattering regions 31 and a portion corresponding to the total-reflection region 32 when only the second light source 7 is turned on, the lighting state of the first light source 2 is appropriately adjusted (ON/OFF control or the lighting amount of the first light source 2 is adjusted) to allow an entire luminance distribution to be optimized. However, for example, in the case where luminance is sufficiently corrected in the display section 1 when two-dimensional display is performed, it is only necessary to turn on the second light source 7.

### [Specific Configuration Examples of Scattering Region 31]

Specific configuration examples of the scattering region 31 will be described referring to FIGS. 7 to 10. FIGS. 7 to 10 illustrate configuration examples in the case where a plurality of scattering regions 31 continuously extending in the vertical direction are arranged side by side in a striped form. The light-scattering characteristics are added to the scattering regions 31 through forming a plurality of asperities 41 in the scattering regions 31. Moreover, the scattering regions 31 have a configuration in which density of the asperities 41 varies with a distance from the first light source 2. In the case where a width of each of the scattering regions 31 is uniform in the extending direction, when the density of the asperities 41 is uniform irrespective of the distance from the first light source 2, the amount of light emitted from the light guide plate 3 increases with decreasing distance from the first light source 2, and luminance of the emitted light increases with decreasing distance from the first light source 2. Therefore, in-plane luminance becomes nonuniform. When the density of the asperities 41 varies with the distance from the first light source 2, non-uniformity of the in-plane luminance is allowed to be reduced.

FIG. 7 illustrates a first configuration example of the scattering region 31 when the first light sources 2 are disposed on a first side surface and a second side surface in the vertical direction (the Y direction) in the light guide plate 3 to face each other. In this configuration example, the light-scattering characteristics are added to the scattering regions 31 through forming a plurality of very small asperities 41 on a surface corresponding to each of the scattering regions 31 of the light guide plate 3 by, for example, laser processing or sandblast processing. Moreover, as illustrated in FIG. 7, the density of the asperities 41 varies with the distance from each of the first light sources 2 (distances from the first side surface and the second side surface of the light guide plate 3). More specifically, the density of the asperities 41 increases with increasing distance from each of the first light sources 2. Since the first light sources 2 are disposed on two side surfaces in the Y direction, each of the scattering regions 31 is configured to have the highest density of the asperities 41 in a central portion in the Y direction. When light enters each of the scattering regions 31, probability that light is applied to the asperities 41 is increased through increasing the density of the asperities 41 with increasing distance from each of the first light sources 2. When the probability that light is applied to the asperities is increased, probability that light is scattered and reflected to exit from the light guide plate 3 is also increased. In other words, luminance is improved.

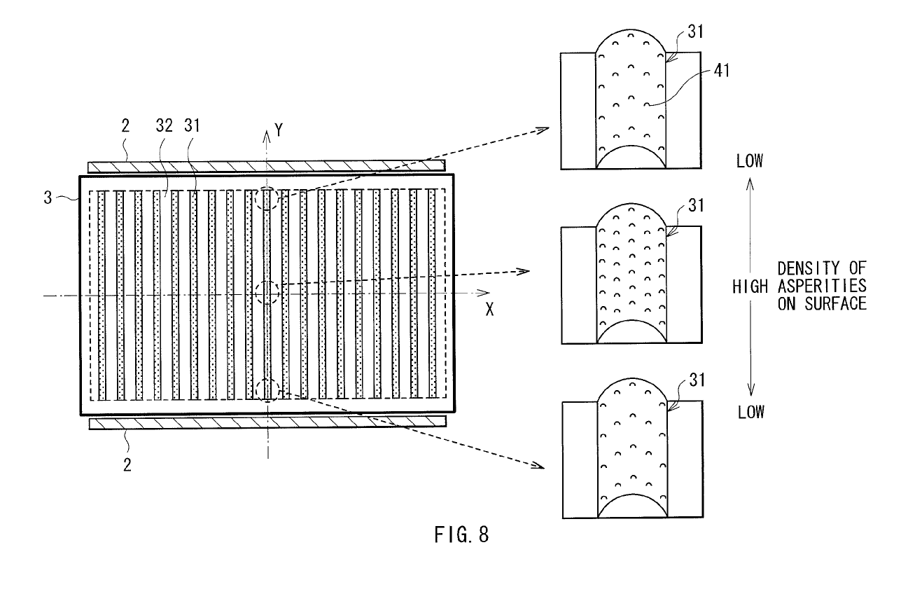

FIG. 8 illustrates a second configuration example of the scattering region 31 when the first light sources 2 are disposed on the first side surface and the second side surface in the vertical direction (the Y direction) in the light guide plate 3 to face each other. In this configuration example, as illustrated in FIG. 8, one scattering region 31 is formed in a steric convex pattern as a whole. The light-scattering characteristics are added to the scattering regions 31 through forming a plurality of very small asperities 41 on a surface (an interface) of the steric pattern by, for example, laser processing or sandblast processing. As with the configuration example in FIG. 7, the density of the asperities 41 varies with the distance from each of the first light sources 2 (the distances from the first side surface and the second side surface of the light guide plate 3).

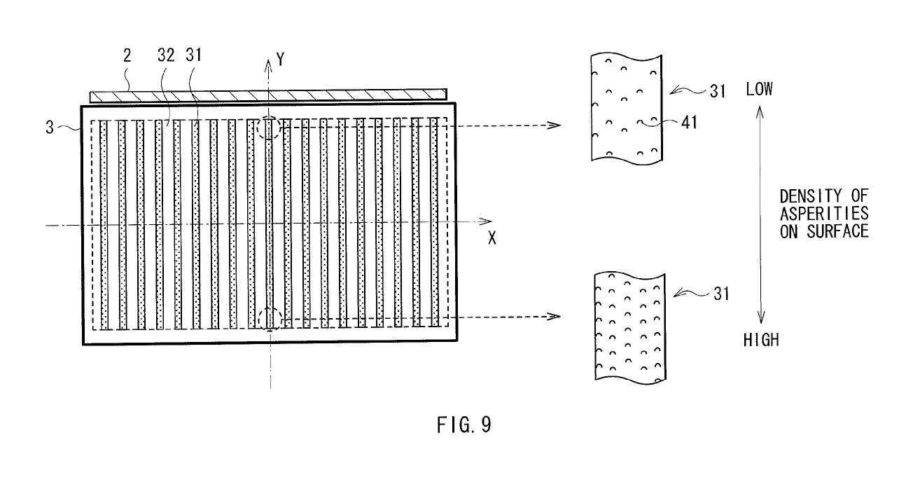

FIG. 9 illustrates a configuration example of the scattering region 31 when the first light source 2 is disposed only on the first side surface in the vertical direction (the Y direction) in the light guide plate 3. In this configuration example, only one first light source 2 is disposed, unlike the configuration example illustrated in FIG. 7. Since the first light source 2 is disposed only on the first side surface (an upper side surface) in the Y direction, the density of the asperities 41 decreases with decreasing distance to the first side surface, and increases with decreasing distance to the second side surface (a lower side surface) in the Y direction. It is to be noted that, also in this configuration example, as with the configuration example in FIG. 8, one scattering region 31 may be configured in a steric convex pattern as a whole.

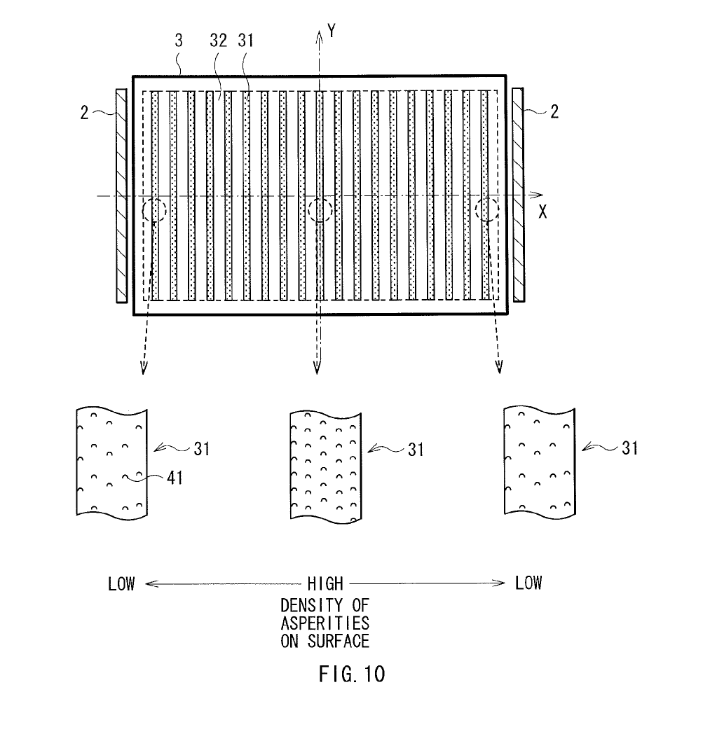

FIG. 10 illustrates a configuration example of the scattering region 31 when the first light sources 2 are disposed on a third side surface and a fourth side surface in a horizontal direction (the X direction) in the light guide plate 3 to face each other. Since, in this configuration example, unlike the configuration example in FIG. 7, the first light sources 2 are disposed in the X direction, the scattering region 31 is configured to have the highest density of the asperities 41 in a central portion in the X direction. Moreover, the density of the asperities 41 decreases with decreasing distance to each of the third side surface and the fourth side surface in the X direction. It is to be noted that, also in this configuration example, as with the configuration example in FIG. 8, one scattering region 31 may be configured in a steric convex pattern as a whole.

It is to be noted that, when the luminance distribution of light emitted from the first light source 2 is improved by any of the configurations illustrated in FIGS. 7 to 10, the angular distribution of luminance of light emitted from the second light source 7 preferably approximate to the angular distribution of luminance of light emitted from the first light source 2. For example, as with the above-described configurations of the scattering region 31, a plurality of very small asperities are preferably formed on a front surface of the second light source 7 by, for example, sandblast processing.

### [Optimization of Angular Distribution of Luminance of Light by Reverse Prism Sheet 50]

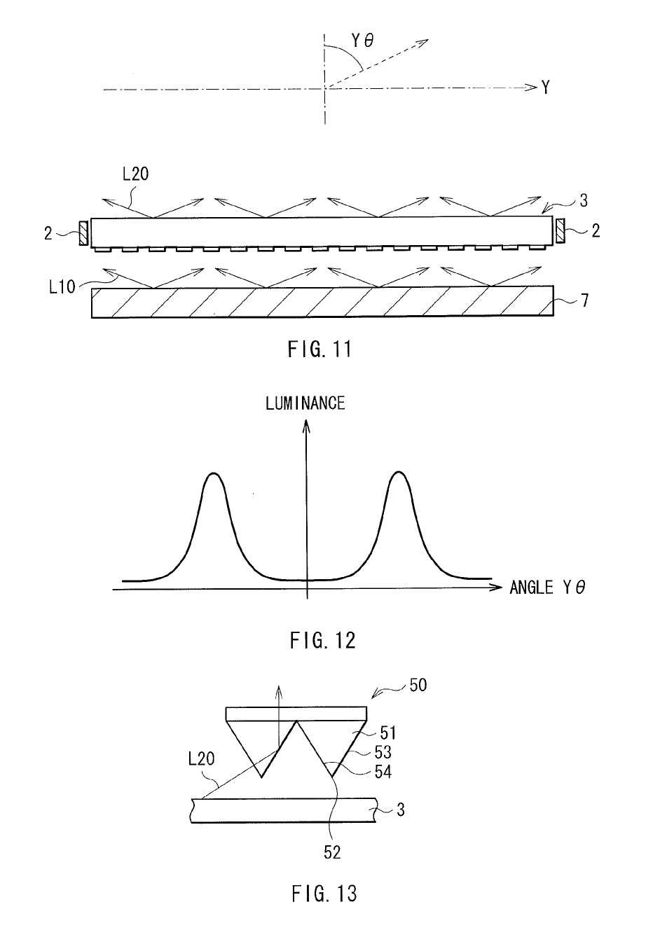

Non-uniformity of the in-plane luminance distribution by the distance from the first light source 2 is allowed to be reduced by any of the above-described configurations in FIGS. 7 to 10. On the other hand, the angular distribution of luminance of light emitted from the light guide plate 3 may vary from a desired state depending on roughness of the asperities 41 in the scattering region 31. For example, as illustrated in FIGS. 11 and 12, light emitted from the first light source 2 does not travel toward a front direction to cause a reduction in front luminance. In other words, light emitted from the first light source 2 has an angular distribution of luminance, where luminance in an oblique direction is higher than luminance in a direction of a normal to a surface of the light guide plate 3. FIG. 12 illustrates an angular distribution of luminance at an angle Yθ in the Y direction of light emitted from the first light source 2, as illustrated in FIG. 11. Moreover, FIG. 12 illustrates an angular distribution of luminance of light when the first light sources 2 are disposed on the first side surface and the second side surface in the vertical direction (the Y direction) in the light guide plate 3 to face each other. It is to be noted that, when the second light source 7 has a configuration in which the angular distribution of luminance of light emitted from the second light source 7 approximate to the angular distribution of luminance of light emitted from the first light source 2 in the above-described manner, the angular distribution of luminance may vary in a similar manner.

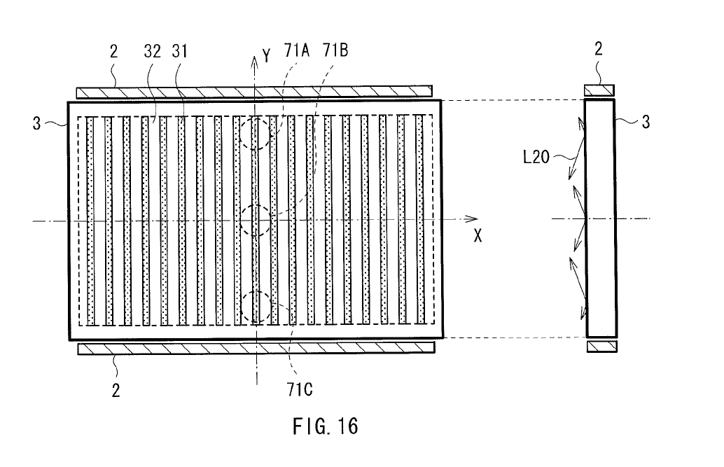

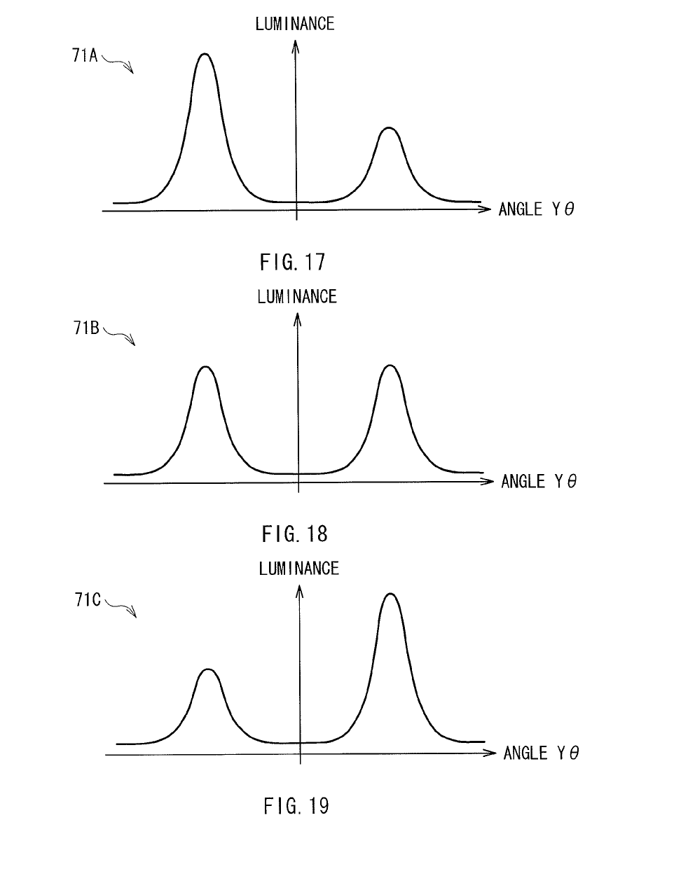

For example, as illustrated in FIGS. 16 to 19, the angular distribution of luminance may vary differently depending on an in-plane position. FIG. 17 illustrates an example of an angular distribution of luminance of light emitted from the first light source 2 on an upper portion (a first region 71A) in the Y direction as illustrated in FIG. 16. FIG. 18 illustrates an example of an angular distribution of luminance of light emitted from the first light source 2 in a central portion (a second region 71B) as illustrated in FIG. 16. FIG. 19 illustrates an example of an angular distribution of luminance of light emitted from the first light source 2 on a lower portion (a third region 71C) in the Y direction as illustrated in FIG. 16. In FIGS. 17 to 19, an angular distribution of luminance at the angle Yθ in the Y direction is illustrated as with FIG. 12. Moreover, FIGS. 17 to 19 illustrate the angular distribution of luminance when the first light sources 2 are disposed on the first side surface and the second side surface in the vertical direction (the Y direction) in the light guide plate 3 to face each other.

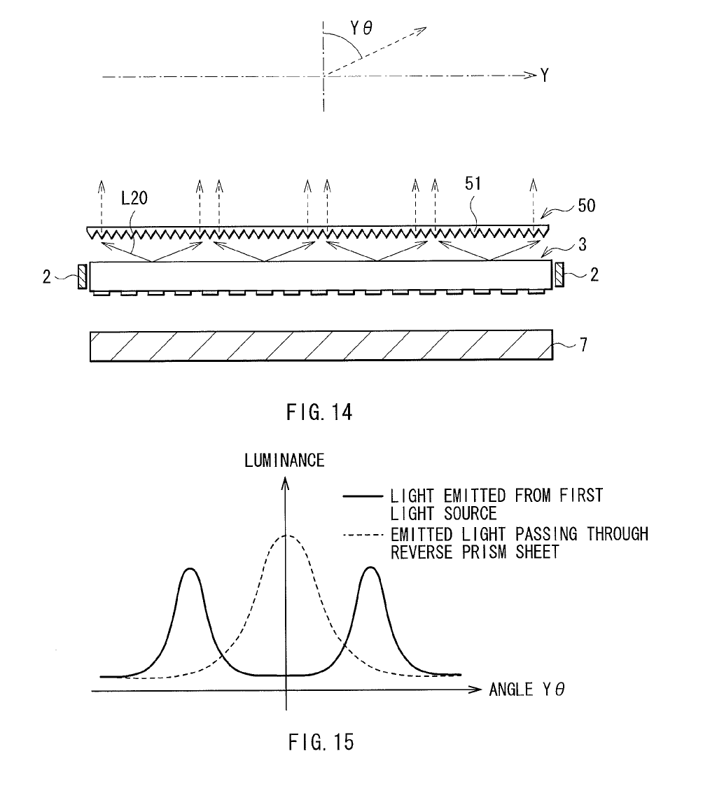

As illustrated in FIGS. 13 to 15, the reverse prism sheet 50 reduces the above-described variations in the angular distribution of luminance through shifting light emitted from the light guide plate 3 toward the front direction (the direction of the normal to the surface of the light guide plate 3). Each of the reverse prisms 51 of the reverse prism sheet 50 includes a first oblique plane 53, a second oblique plane 54, and a ridgeline 52 which is formed at an intersection of the first oblique plane 53 and the second oblique plane 54, as illustrated in FIG. 13. As illustrated in FIGS. 13 and 14, a traveling direction of light emitted from the light guide plate 3 is changed at the first oblique plane 53 and the second oblique plane 54 of the reverse prism 51 through refraction and total reflection.

As described above, in each of the first light source 2 and the second light source 7, light emitted from the light guide plate 3 has an angular distribution of luminance, where luminance in the oblique direction is higher than luminance in the direction of the normal to the surface of the light guide plate 3. The reverse prism sheet 50 allows an angular distribution of luminance of light emitted from the light guide plate 3 to be so varied as to increase luminance at least in the direction of the normal, thereby improving the angular distributions of luminance of light in each of the first light source 2 and the second light source 7. More preferably, the reverse prism sheet 50 allows the angular distribution of luminance of light emitted from the light guide plate 3 to be so varied as to decrease luminance in the oblique direction. Thus, the emitted light after passing through the reverse prism sheet 50 has an angular distribution of luminance, where luminance in the front direction is highest, as illustrated by a dotted line in FIG. 15.

It is to be noted that, although an effect by the reverse prism sheet 50 when the first light sources 2 are disposed on the first side surface and the second side surface in the vertical direction (the Y direction) in the light guide plate 3 to face each other is described above, a similar effect is obtained when the first light sources 2 are disposed on the third side surface and the fourth side surface in the horizontal direction (the X direction) to face each other (refer to FIG. 10).

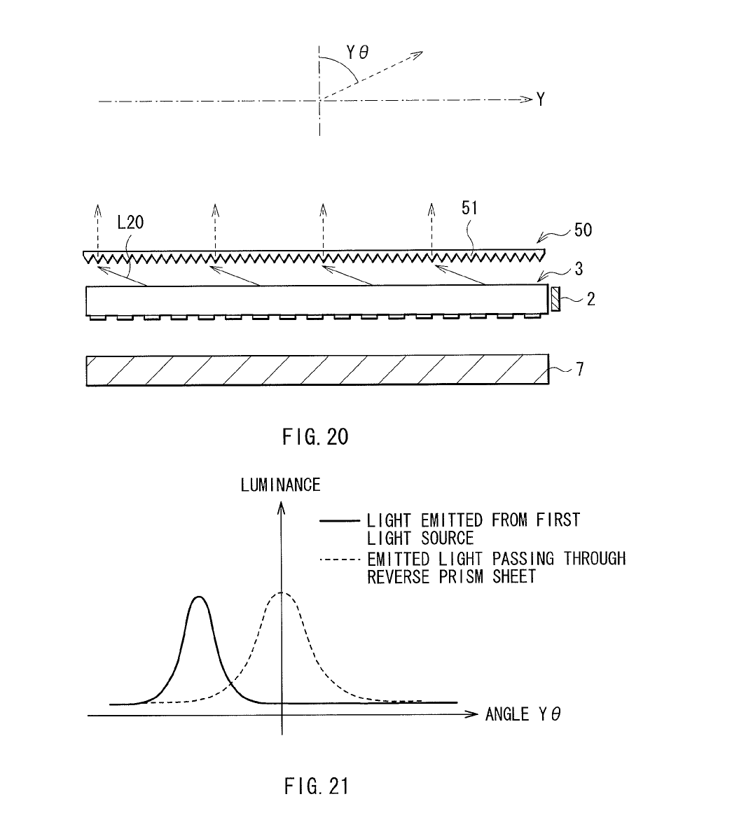

Moreover, for example, as illustrated in FIGS. 20 and 21, an angular distribution of luminance of light when only one first light source is provided is also improvable. FIGS. 20 and 21 illustrate an example when the first light source 2 is disposed only on the first side surface in the vertical direction (the Y direction) in the light guide plate 3. In this case, light emitted from the light guide plate 3 has an angular distribution of luminance, where luminance in an oblique direction is high on a side opposite to a side where the first light source 2 is disposed, as indicated by a solid line in FIG. 21. Also in this case, the reverse prism sheet 50 allows the angular distribution of luminance of light emitted from the light guide plate 3 to be so varied as to increase luminance at least in the direction of the normal, thereby improving the angular distribution of luminance. More preferably, the reverse prism sheet 50 allows the angular distribution of luminance of the light emitted from the light guide plate 3 to be so varied as to decrease luminance in the oblique direction. Thus, the emitted light passing through the reverse prism sheet 50 has an angular distribution of luminance, where luminance in the front direction is highest, as indicated by a dotted line in FIG. 21.

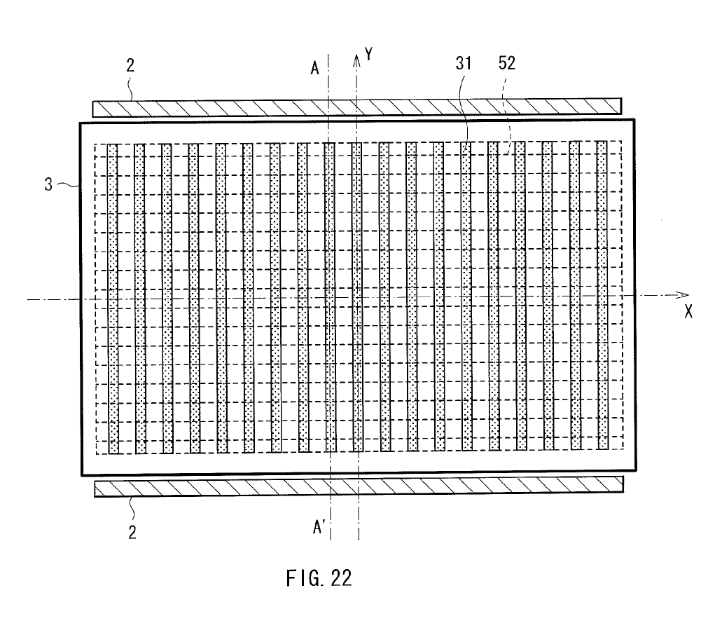

Optimization of the angular distribution of luminance of light is achievable by the reverse prism sheet 50 in the above-described manner, and in this case, the ridgeline 52 of each prism in the reverse prism sheet 50 and an extending direction of each of the scattering regions 31 are preferably orthogonal to each other not only in the case where the first light sources 2 are disposed on the first side surface and the second side surface in the vertical direction (the Y direction) in the light guide plate 3 to face each other, as illustrated in FIG. 22, but also in the case where the first light sources 2 are disposed on the third side surface and the fourth side surface in the horizontal direction (the X direction) to face each other, as illustrated in FIG. 23.

When the ridgeline 52 of each prism in the reverse prism sheet 50 and the extending direction of each of the scattering regions 31 are not orthogonal to each other, in the case where 3D display is performed by the first light sources 2, an unnecessary region emits light to cause an increase in crosstalk. Moreover, to suppress crosstalk, it is preferable that the reverse prism sheet 50 not include a volume scattering object such as haze in a material thereof, and a prism plane and a plane located closer to the display section 1 be nearly mirror planes.

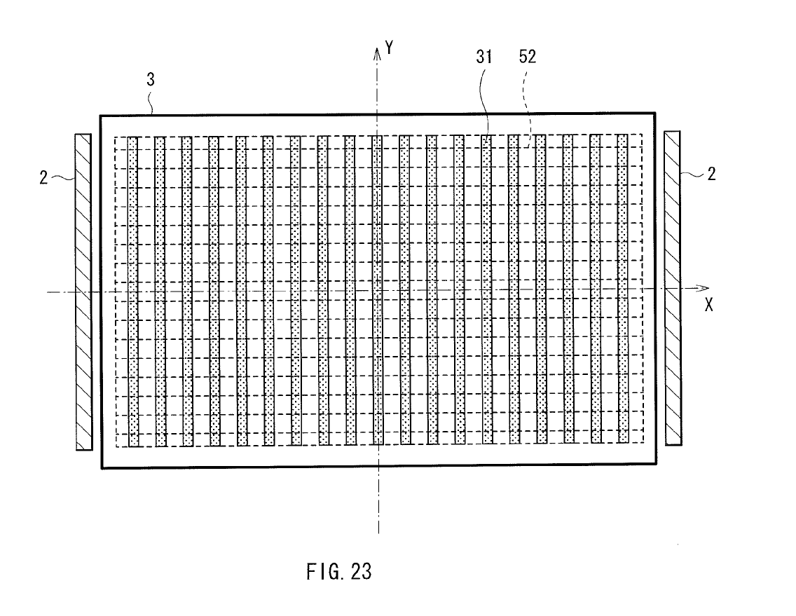

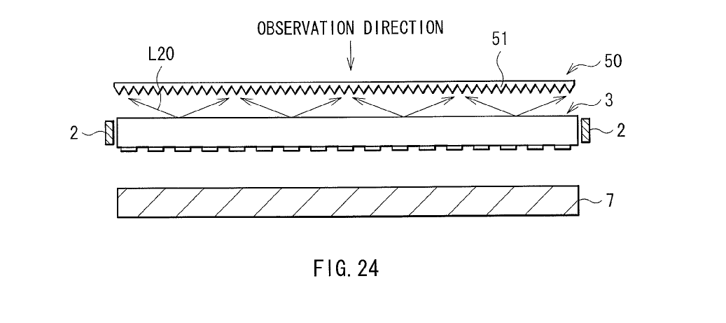

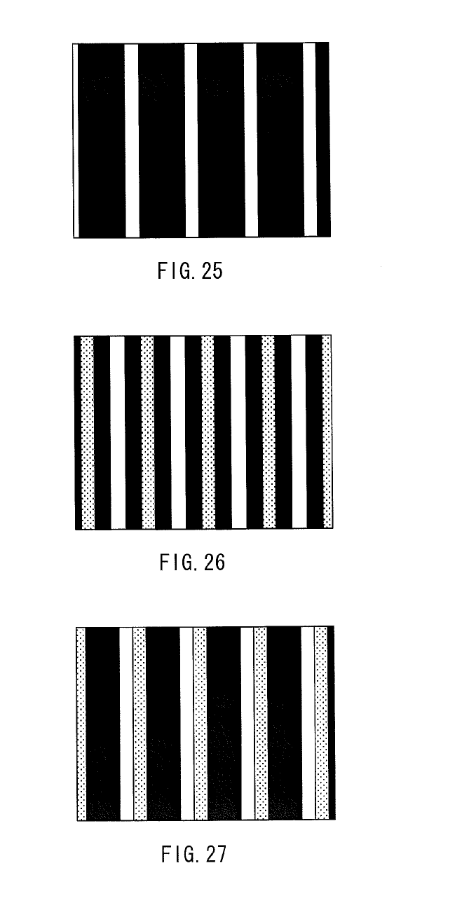

FIG. 25 illustrates an enlarged view of a light emission state by the first light source 2 when the light guide plate 3 is viewed from the front direction in the case where the ridgeline 52 of each prism in the reverse prism sheet 50 and the extending direction of each of the scattering regions 31 are orthogonal to each other. In FIG. 25, only portions corresponding to the scattering regions 31 emit light. On the other hand, FIGS. 26 and 27 illustrate enlarged views of a light emission state by the first light source 2 when the ridgeline 52 of each prism in the reverse prism sheet 50 and the extending direction of each of the scattering regions 31 are not orthogonal to each other. In FIGS. 26 and 27, unnecessary regions other than the portions corresponding to the scattering regions 31 emit light. In such a state, crosstalk occurs when 3D display is performed. It is to be noted that FIGS. 25 to 27 each illustrate a state observed from a direction of a normal to a surface of the reverse prism sheet 50, as illustrated in FIG. 24.

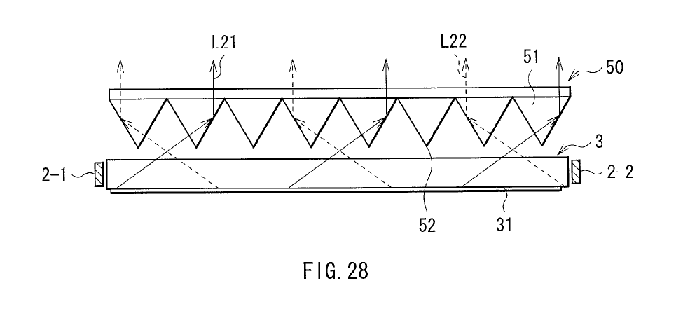

A reason why the light emission state differs by a relationship between the ridgeline 52 of each prism in the reverse prism sheet 50 and the extending direction of each of the scattering regions 31, as illustrated in FIGS. 25 to 27, will be described below referring to FIG. 28. FIG. 28 illustrates behavior of light rays at a section A-A′ (refer to FIG. 22) in a direction parallel to the pattern of the scattering region 31 in the light guide plate 3. FIG. 28 illustrates an example when an upper light source 2-2 and a lower light source 2-1 are disposed in the vertical direction (the Y direction) in the light guide plate 3. In FIG. 28, a light ray L21 emitted from the lower light source 2-1 is indicated by a solid line, and a light ray L22 emitted from the upper light source 2-2 is indicated by a dotted line. When light enters from such two directions, light emitted from the light guide plate 3 has peaks in two directions. Light emitted from the lower light source 2-1 and light emitted from the upper light source 2-2 are emitted toward a right above direction while being maintained parallel to each other through disposing the ridgeline 52 of each of the reverse prisms 51 and the extending direction of each of the scattering regions 31 orthogonal to each other. Therefore, when the ridgeline 52 of each of the reverse prisms 51 and the extending direction of each of the scattering regions 31 are not orthogonal to each other, the light ray L21 emitted from the lower light source 2-1 and the light ray L22 emitted from the upper light source 2-2 are not emitted just above the pattern, and the light emission state is turned to the state illustrated in FIG. 26 or 27.

### [Effects]

As described above, in the display unit according to the embodiment, the scattering regions 31 and the total reflection region 32 are disposed on the second internal reflection plane 3B of the light guide plate 3, and the light guide plate 3 allows the first illumination light L1 from the first light source 2 and the second illumination light L10 from the second light source 7 to selectively exit therefrom; therefore, the light guide plate 3 equivalently functions as a parallax barrier. Thus, compared to the parallax barrier system stereoscopic display unit in related art, the number of components is reduced, and space saving is achievable.

Moreover, in the display unit according to the embodiment, since a density distribution of the asperities 41 in each of the scattering regions 31 varies with the distance from the first light source 2, uniformization of the in-plane luminance distribution is achievable through improving a luminance distribution in three-dimensional display. Further, since the reverse prism sheet 50 is included as an optical member allowing the angular distribution of luminance of light emitted from the light guide plate 3 to be varied; therefore, illumination light with a desired angular distribution of luminance is obtainable through reducing variations in angular distribution of luminance of light caused by the asperities 41 provided to the scattering regions 31.

### [Verification of Effects by Reverse Prism Sheet 50]

To verify effects by the reverse prism sheet 50, measurement for the following two points was executed. As the reverse prism sheet 50, a reverse prism sheet with an apex angle of 65° and a pitch of 18 μm was used.

(1) Verify whether a light distribution direction of light emitted from the light guide plate 3 is turned to the front direction by combination of the light guide plate 3 with a plurality of asperities 41 formed in the scattering regions 31 by sandblast processing and the reverse prism sheet 50

(2) Verify whether a light distribution direction of light after passing through the reverse prism sheet 50 is turned to the front direction by use of a light guide plate in which a surface of the second light source 7 is subjected to sandblast processing similar to that subjected to the scattering regions 31

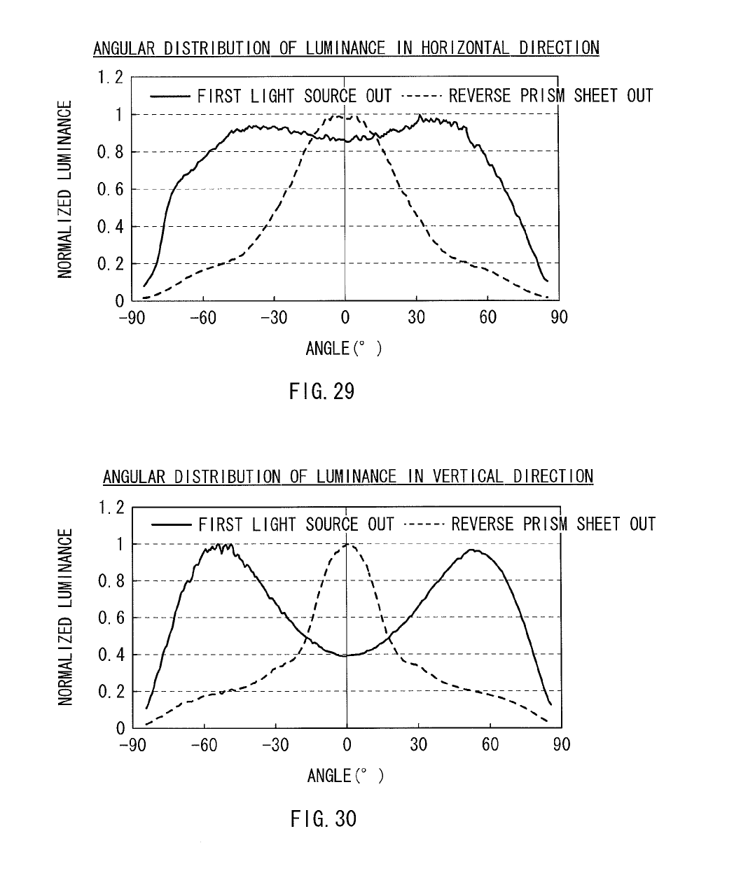

FIG. 29 illustrates an angular distribution of luminance in the horizontal direction (the X direction) of light emitted from the first light source 2. FIG. 30 illustrates an angular distribution of luminance in the vertical direction (the Y direction) of light emitted from the first light source 2. In FIGS. 29 and 30, an angular distribution of luminance of light emitted from the first light source 2 after passing through the reverse prism sheet 50 and an angular distribution of luminance of light emitted from the first light source 2 in the case where the reverse prism sheet 50 is not provided are illustrated together. As illustrated in FIGS. 29 and 30, it was confirmed that light emitted from the first light source 2 was turned to the front direction after passing through the reverse prism sheet 50.

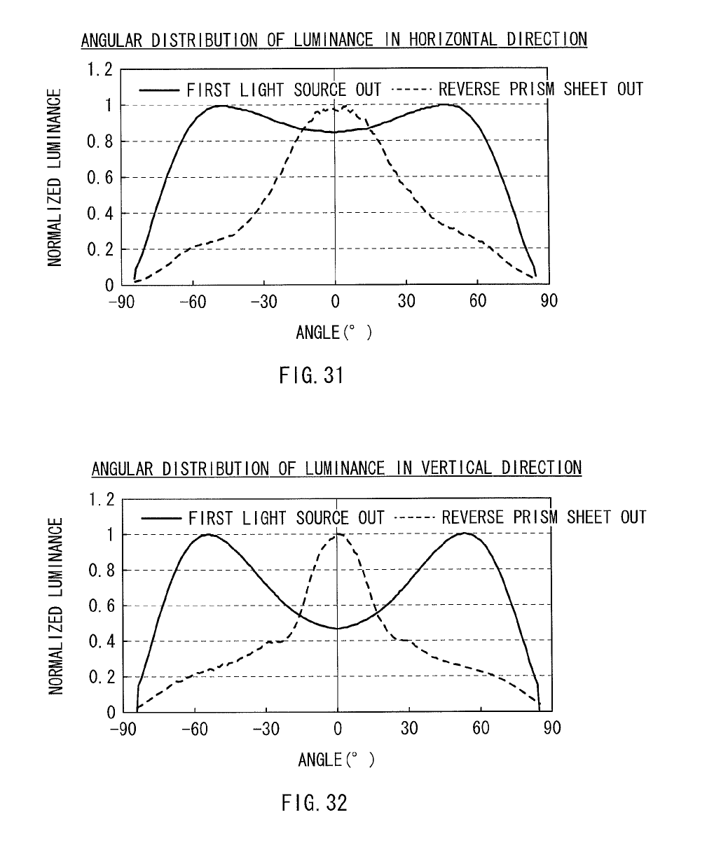

FIG. 31 illustrates an angular distribution of luminance in the horizontal direction (the X direction) of light emitted from the second light source 7. FIG. 32 illustrates an example of an angular distribution of luminance in the vertical direction (the Y direction) of light emitted from the second light source 7. In FIGS. 31 and 32, an angular distribution of luminance of light emitted from the second light source 7 after passing through the reverse prism sheet 50 and an angular distribution of luminance of light emitted from the second light source 7 in the case where the reverse prism sheet 50 is not provided are illustrated together. As illustrated in FIGS. 31 and 32, it was confirmed that the angular distribution of luminance of light emitted from the second light source 7 were substantially equal to those of light emitted from the first light source 2, and the light emitted from the second light source 7 was turned toward the front direction after passing through the reverse prism sheet 50.

### 2. Second Embodiment

Next, a display unit according to a second embodiment will be described below. It is to be noted that like components are denoted by like numerals as of the display unit according to the first embodiment and will not be further described.

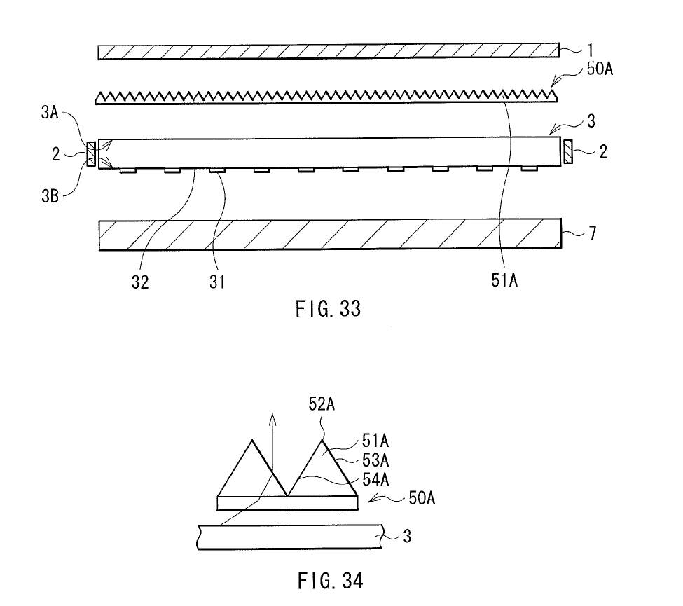

FIG. 33 illustrates a configuration example of the display unit according to the second embodiment of the present disclosure. The display unit includes an upward prism sheet 50A as an optical member instead of the reverse prism sheet 50 in the display unit in FIG. 1.

The upward prism sheet 50A reduces the above-described variations in angular distribution of luminance of light through shifting light emitted from the light guide plate 3 toward the front direction as with the reverse prism sheet 50 in the first embodiment. The upward prism sheet 50A includes a plurality of upward prisms 51A. As illustrated in FIG. 34, each of the upward prisms 51A includes a first oblique plane 53A, a second oblique plane 54A, and a ridgeline 52A which is formed at an intersection of the first oblique plane 53A and the second oblique plane 54A. As illustrated in FIG. 34, a traveling direction of light emitted from the light guide plate 3 is changed at the first oblique plane 53A and the second oblique plane 54A of each of the upward prisms 51A at least through refraction.

### 3. Third Embodiment

Next, a display unit according to a third embodiment of the present disclosure will be described below. It is to be noted that like components are denoted by like numerals as of the display units according to the first and second embodiments and will not be further described.

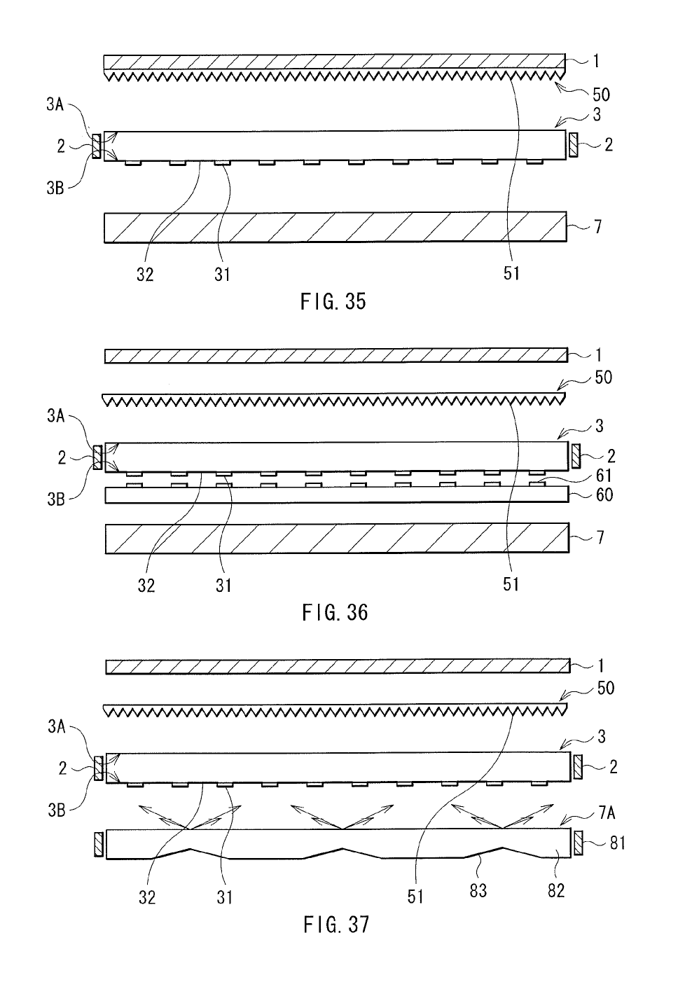

FIG. 35 illustrates a configuration example of the display unit according to the third embodiment. In the display unit in FIG. 1, the reverse prism sheet 50 and the display section 1 are disposed with spacing; however, in the display unit according to this embodiment, the reverse prism sheet 50 and the display section 1 are bonded together.

An effect in the case where the reverse prism sheet 50 and the display section 1 were bonded together in such a manner was verified. In the case where 3D display was performed, a crosstalk amount in the case where the reverse prism sheet 50 and the display section 1 were bonded together and a crosstalk amount in the case where the reverse prism sheet 50 and the display section 1 were not bonded together were measured. It was confirmed that, compared to the case where the reverse prism sheet 50 and the display section 1 were not bonded together, in the case where the reverse prism sheet 50 and the display section 1 were bonded together, the crosstalk amount was reduced from 12.6% to 8.8%, because an air interface was reduced through bonding the display section 1 and the reverse prism sheet 50 together.

### 4. Fourth Embodiment

Next, a display unit according to a fourth embodiment of the present disclosure will be described below. It is to be noted that like components are denoted by like numerals as of the display units according to the first to third embodiments and will not be further described.

FIG. 36 illustrates a configuration example of the display unit according to the fourth embodiment. The display unit is different from the display unit in FIG. 1 in that the display unit further includes a transparent or semi-transparent substrate 60 having reflection sections 61. The substrate 60 is disposed to face the light guide plate 3 on a side opposite to an emission direction of light from the first light source 2 (a side opposite to a side facing the display section 1). The reflection sections 61 have a role in reflecting back light from the first light source 2 into the light guide plate 3 so as not to allow the light from the first light source 2 to be emitted in a direction opposite to an original emission direction. The reflection sections 61 are disposed in positions corresponding to the scattering regions 31. Light use efficiency is improvable through providing the reflection sections 61.

The reflection sections 61 are configured of, for example, a film of metal formed on the substrate 60. As the metal forming the reflection sections 61, high-reflectivity metal with favorable spectral characteristics, such as Al or Ag is preferable. The substrate 60 may be disposed with spacing from the light guide plate 3 as illustrated in the configuration example in FIG. 36, or may be disposed to allow the reflection sections 61 and the scattering regions 31 to be adhered to each other. Moreover, a metal film may be formed directly on surface portions corresponding to the scattering regions 31 of the light guide plate 3, instead of forming the reflection sections 61 on the substrate 60. Further, the reflection section 61 may be made of a scattering resin such as white ink, instead of the metal film.

Moreover, instead of the substrate 60 having the reflection sections 61, a neutral density filter may be provided.

### 5. Fifth Embodiment

Next, a display unit according to a fifth embodiment of the present disclosure will be described below. It is to be noted that like components are denoted by like numerals as of the display units according to the first to fourth embodiments and will not be further described.

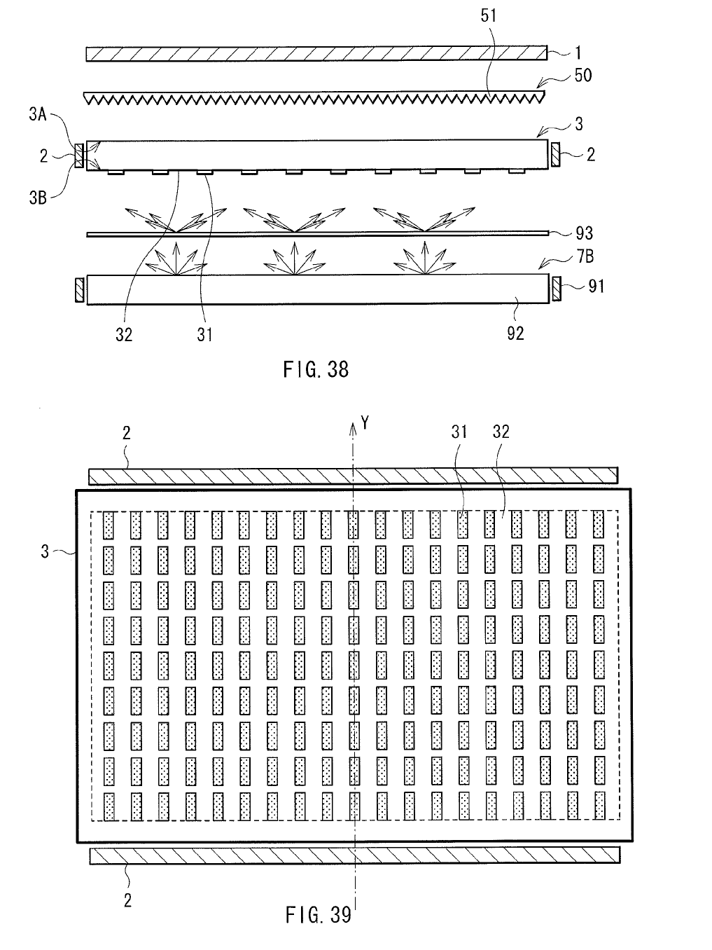

In the first embodiment, an example in which a plurality of very small asperities are formed on the front surface of the second light source 7 by, for example, sandblast processing so as to allow the angular distribution of luminance of light emitted from the second light source 7 to approximate to the angular distribution of luminance of light emitted from the first light source 2 is described; however, a different configuration may be adopted. FIGS. 37 and 38 illustrate modifications of the second light source 7.

A second light source 7A illustrated in FIG. 37 is a light guide plate system surface light source, and includes a light source section 81 and a light guide plate 82. The light guide plate 82 is a prism light guide plate, and includes a prism section 83 on a bottom surface thereof. The prism section 83 is configured of a mirror plane.

A second light source 7B illustrated in FIG. 38 is a light guide plate system surface light source, and includes a light source section 91 and a light guide plate 92. The second light source 7B further includes a second reverse prism sheet 93 on a light emission side thereof. The second light source 7B is a planar light source, and has a uniform in-plane angular distribution of luminance. The second reverse prism sheet 93 allows an angular distribution of luminance of light emitted from the second light source 7B to approximate to an angular distribution of luminance of light emitted from the first light source 2.

It is to be noted that, in FIG. 38, the second light source 7B is an edge light system surface light source; however, the second light source 7B may be a direct-type surface light source.

### 6. Other Embodiments

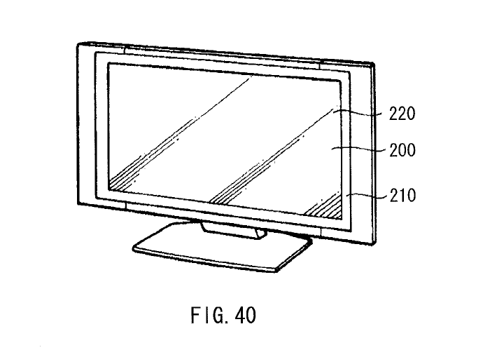

Although the present disclosure is described referring to the above-described embodiments, the present disclosure is not limited thereto, and may be variously modified. For example, the display units according to the above-described embodiments each are applicable to various electronic apparatuses having a display function. FIG. 40 illustrates an appearance configuration of a television as an example of such an electronic apparatus. The television includes an image display screen section 200 including a front panel 210 and a filter glass 220.

Moreover, in the above-described embodiments, a configuration example in which the scattering regions 31 and the total reflection region 32 are disposed on the second internal reflection plane 3B in the light guide plate 3 is described; however, the scattering regions 31 and the total reflection region 32 may be disposed on the first internal reflection plane 3A.

Further, in the above-described embodiments, the reverse prism sheet 50 and the upward prism sheet 50A are described as examples of the optical member allowing the angular distribution of luminance of light to be varied; however, any other optical member including a plurality of portions changing a traveling direction of incident light at least through refraction may be used. For example, a lens sheet including a plurality of lenses with refraction as the portions changing the traveling direction of light may be used.

In the above-described embodiments, a configuration example in which a plurality of scattering regions 31 continuously extending in the vertical direction are arranged side by side in a striped form is described; however, for example, as illustrated in FIG. 39, the scattering regions 31 may have a pattern intermittently extending in the vertical direction.

In the above-described embodiments, as illustrated in FIG. 7 and the like, light-scattering characteristics are added to the scattering regions 31 through forming a plurality of asperities 41 on the surface of the scattering region 31; however, the surface of the scattering region 31 may be coated with a material having light-scattering characteristics such as white ink.

The technology of the present disclosure may have the following configurations.

(1) A display unit including:

a display section displaying an image; and

a light source device emitting light for image display toward the display section, the light source device including one or more first light sources, a light guide plate, and an optical member, the first light sources emitting first illumination light, the light guide plate including a plurality of scattering regions that allow the first illumination light to be scattered and then to exit from the light guide plate, the optical member being disposed on a light-emission side of the light guide plate to face the light guide plate and allowing an angular distribution of luminance of the first illumination light emitted from the light guide plate to be varied.

(2) The display unit according to (1), in which

the first illumination light exiting from the light guide plate has an angular distribution of luminance, where luminance in an oblique direction is higher than luminance in a direction of a normal to a surface of the light guide plate, and

the optical member allows the luminance of the first illumination light in the direction of the normal to the surface of the light guide plate to be increased.

(3) The display unit according to (1) or (2), in which the optical member includes a plurality of portions each allowing a traveling direction of incident light to be changed at least through refraction.

(4) The display unit according to (3), in which

the portions changing the traveling direction of light are configured of prisms each having a first oblique plane, a second oblique plane, and a ridgeline, the ridgeline being formed at an intersection of the first oblique plane and the second oblique plane,

each of the plurality of scattering regions is disposed in a fashion to configure a pattern continuously extending in a predetermined direction or a pattern intermittently extending in the predetermined direction, and

the ridgeline of each of the prisms and the extending direction of each of the scattering regions are orthogonal to each other.

(5) The display unit according to any one of (1) to (4), in which

the light guide plate has a plurality of side surfaces,

the one or more first light sources are disposed to face one or more of the side surfaces of the light guide plate, and

each of the scattering regions has, on a surface thereof, a plurality of asperities that provide a light-scattering function, and density of the asperities varies with a distance from the first light source.

(6) The display unit according to (5), in which density of the asperities in each of the scattering regions increases with increasing distance from the first light source.

(7) The display unit according to any one of (1) to (6), further including a second light source disposed to face the light guide plate, the second light source applying second illumination light toward the light guide plate from a direction different from a light-application direction of the first light source,

in which the optical member allows an angular distribution of luminance of the second illumination light exiting from the light guide plate, as well as the angular distribution of luminance of the first illumination light, to be varied.

(8) The display unit according to (7), in which

the second illumination light has an angular distribution of luminance, where luminance in an oblique direction is higher than luminance in a direction of a normal to a surface of the light guide plate, and

the optical member allows the luminance of the second illumination light in the direction of the normal to the surface of the light guide plate to be increased.

(9) The display unit according to (7), in which

the display section selectively switches images to be displayed between perspective images based on three-dimensional image data and an image based on two-dimensional image data, and

the second light source is controlled to be turned off when the perspective images are to be displayed on the display section, and is controlled to be turned on when the image based on the two-dimensional image data is to be displayed on the display section.

(10) The display unit according to (9), in which the first light source is controlled to be turned on when the perspective images are to be displayed on the display section, and is controlled to be either turned off or turned on when the image based on the two-dimensional image data is to be displayed on the display section.

(11) The display unit according to any one of (1) to (10), further including a reflection member disposed to face the light guide plate on an opposite side of the light-emission side of the light guide plate, and allowing the first illumination light, that has exited from the light guide plate onto the opposite side of the light-emission side, to reflect back into the light guide plate.

(12) A light source device including:

one or more first light sources emitting first illumination light;

a light guide plate including a plurality of scattering regions that allow the first illumination light to be scattered and then to exit from the light guide plate; and

an optical member disposed on a light-emission side of the light guide plate to face the light guide plate and allowing an angular distribution of luminance of the first illumination light emitted from the light guide plate to be varied.

(13) An electronic apparatus provided with a display unit, the display unit including:

a display section displaying an image; and

a light source device emitting light for image display toward the display section, the light source device including one or more first light sources, a light guide plate, and an optical member, the first light sources emitting first illumination light, the light guide plate including a plurality of scattering regions that allow the first illumination light to be scattered and then to exit from the light guide plate, the optical member being disposed on a light-emission side of the light guide plate to face the light guide plate and allowing an angular distribution of luminance of the first illumination light emitted from the light guide plate to be varied.

The present disclosure contains subject matter related to that disclosed in Japanese Priority Patent Application No. 2012-169218 filed in the Japan Patent Office on Jul. 31, 2012, the entire content of which is hereby incorporated by reference.

It should be understood by those skilled in the art that various modifications, combinations, sub-combinations, and alterations may occur depending on design requirements and other factors insofar as they are within the scope of the appended claims or the equivalents thereof.

What is claimed is:

1. A display unit comprising:
a display section displaying an image; and
a light source device emitting light for image display toward the display section, the light source device including one or more first light sources, a light guide plate, and an optical member, the first light sources emitting first illumination light, the light guide plate including a plurality of scattering regions that allow the first illumination light to be scattered and then to exit from the light guide plate, the optical member being disposed on a light-emission side of the light guide plate to face the light guide plate and allowing an angular distribution of luminance of the first illumination light emitted from the light guide plate to be varied.

2. The display unit according to claim 1, wherein
the first illumination light exiting from the light guide plate has an angular distribution of luminance, where luminance in an oblique direction is higher than luminance in a direction of a normal to a surface of the light guide plate, and
the optical member allows the luminance of the first illumination light in the direction of the normal to the surface of the light guide plate to be increased.

3. The display unit according to claim 1, wherein the optical member includes a plurality of portions each allowing a traveling direction of incident light to be changed at least through refraction.

4. The display unit according to claim 3, wherein
the portions changing the traveling direction of light are configured of prisms each having a first oblique plane, a second oblique plane, and a ridgeline, the ridgeline being formed at an intersection of the first oblique plane and the second oblique plane,
each of the plurality of scattering regions is disposed in a fashion to configure a pattern continuously extending in a predetermined direction or a pattern intermittently extending in the predetermined direction, and
the ridgeline of each of the prisms and the extending direction of each of the scattering regions are orthogonal to each other.

5. The display unit according to claim 1, wherein
the light guide plate has a plurality of side surfaces,
the one or more first light sources are disposed to face one or more of the side surfaces of the light guide plate, and
each of the scattering regions has, on a surface thereof, a plurality of asperities that provide a light-scattering function, and density of the asperities varies with a distance from the first light source.

6. The display unit according to claim 5, wherein density of the asperities in each of the scattering regions increases with increasing distance from the first light source.

7. The display unit according to claim 1, further comprising a second light source disposed to face the light guide plate, the second light source applying second illumination light toward the light guide plate from a direction different from a light-application direction of the first light source,
wherein the optical member allows an angular distribution of luminance of the second illumination light exiting from the light guide plate, as well as the angular distribution of luminance of the first illumination light, to be varied.

8. The display unit according to claim 7, wherein
the second illumination light has an angular distribution of luminance, where luminance in an oblique direction is higher than luminance in a direction of a normal to a surface of the light guide plate, and
the optical member allows the luminance of the second illumination light in the direction of the normal to the surface of the light guide plate to be increased.

9. The display unit according to claim 7, wherein
the display section selectively switches images to be displayed between perspective images based on three-dimensional image data and an image based on two-dimensional image data, and
the second light source is controlled to be turned off when the perspective images are to be displayed on the display section, and is controlled to be turned on when the image based on the two-dimensional image data is to be displayed on the display section.

10. The display unit according to claim 9, wherein the first light source is controlled to be turned on when the perspective images are to be displayed on the display section, and is controlled to be either turned off or turned on when the image based on the two-dimensional image data is to be displayed on the display section.

11. The display unit according to claim 1, further comprising a reflection member disposed to face the light guide plate on an opposite side of the light-emission side of the light guide plate, and allowing the first illumination light, that has exited from the light guide plate onto the opposite side of the light-emission side, to reflect back into the light guide plate.

12. A light source device comprising:
one or more first light sources emitting first illumination light;
a light guide plate including a plurality of scattering regions that allow the first illumination light to be scattered and then to exit from the light guide plate; and
an optical member disposed on a light-emission side of the light guide plate to face the light guide plate and allowing an angular distribution of luminance of the first illumination light emitted from the light guide plate to be varied.

13. An electronic apparatus provided with a display unit, the display unit comprising:
a display section displaying an image; and
a light source device emitting light for image display toward the display section, the light source device including one or more first light sources, a light guide plate, and an optical member, the first light sources emitting first illumination light, the light guide plate including a plurality of scattering regions that allow the first illumination light to be scattered and then to exit from the light guide plate, the optical member being disposed on a light-emission side of the light guide plate to face the light guide plate and allowing an angular distribution of luminance of the first illumination light emitted from the light guide plate to be varied.
